(19) United States
(12) Patent Application Publication
(10) Pub. No.: US 2011/0298648 A1
(43) Pub. Date: Dec. 8, 2011

(54) Method and on board device for providing pilot assistance in the lack of air control

(76) Inventor: Daniel Ferro, Muret (FR)

(21) Appl. No.: 10/810,125

(22) Filed: Mar. 25, 2004

(30) Foreign Application Priority Data
Apr. 1, 2003 (FR) 03 50083

(51) Int. Cl. G01S 13/93; G08G 5/04

(52) U.S. Cl. 342/29

(57) ABSTRACT

A system and method for providing pilot assistance to an aircraft in the lack of air control airspace, within the context of IFBP and TIBA procedures. The system and method includes receiving blind broadcast messages on a dedicated frequency, inputting relevant data regarding the blind broadcast message to a system in which an estimated current position of all broadcasting aircraft within a neighborhood is calculated. In addition, the flight paths being followed as well as direction of flight of the aircraft in the neighborhood extrapolated from the blind broadcast message and preferably displayed to the pilot. In an embodiment, the system displays the trajectories of all broadcasting aircraft in relation to flight path of the pilot's aircraft to determined if a collision is possible.

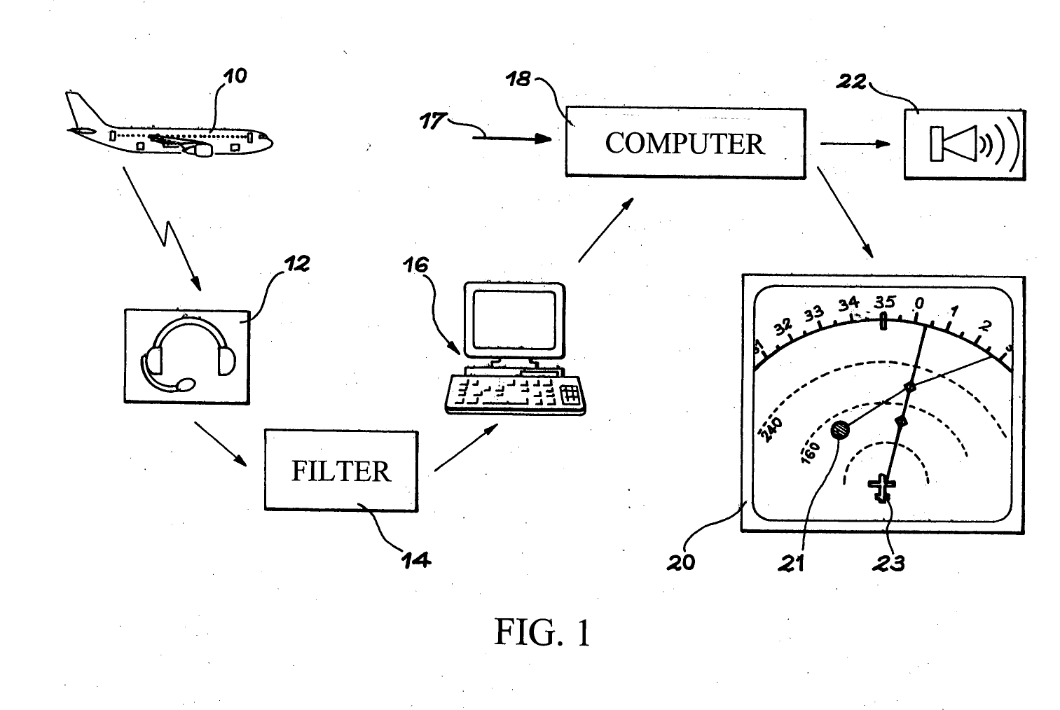

### TECHNICAL DOMAIN

This invention relates to a method and on board device for providing pilot assistance in the lack of air control.

More precisely, it is a device that can be placed onboard an aircraft and a method that can be used almost independently onboard the aircraft.

Air control in some regions of the world, particularly such as Africa and some South American countries, is non-existent or not efficient, and consequently aircraft pilots need to apply special procedures to manage relative positions of other aircraft themselves, to eliminate risks of collision.

The purpose of this invention is to help the pilot manage the situation resulting from this lack of air control. Its purpose is to facilitate the estimate of the risk of conflict between aircraft in a flying area, and to enable aircraft separation. It is particularly useful in regions in which air traffic control on the ground is non-existent or is not very good. Conflict arises when two aircraft are moving too close to each other within the same area; closeness may be considered in terms of distance, altitude and/or route.

### STATE OF PRIOR ART

Aircraft are “separated”, to prevent collisions between aircraft in flight.

This task is usually done on the ground and is usually called ATC (Air Traffic Control). Control may be done by radar, but it may also take place in regions without radar systems. In this case, aircraft separation is governed mainly by assigning different departure times or different altitudes to aircraft.

It is found that ground control of air traffic is absent in some regions in the world, or at least is not sufficiently reliable.

The pilot or the crew of an aircraft flying in one of these zones must apply specific procedures called IFBP (In Flight Broadcast Procedure) or TIBA (Traffic Information Broadcast by Aircraft), and defined by the IATA (International Air Transport Association). These procedures consist of having each pilot make a voice broadcast of information on a dedicated radio frequency defined for the particular geographic zone (for example 126.9 MHz in Africa or 126.95 MHz in South America), at predefined time intervals (for example every 20 minutes) and at aircraft waypoints or altitude changes.

The pilot must also listen to information broadcast by other pilots on the same radio frequency and must interpret this information. The range of radio waves on the dedicated frequency considered is of the order of 700 to 900 km. Therefore, the pilot receives the said information broadcast by the pilots of aircraft located within a sphere with a radius of about 700 to 900 km around him, so that he can be familiar with the surrounding traffic.

However, the amount of interpretation work that the pilot needs to do on the said information to locate his future path with respect to future paths of other aircraft increases as the traffic becomes denser. Consequently, the risk of an interpretation error and therefore a risk of collision between two aircraft increases as the traffic becomes denser. Similarly, the workload resulting from such a task may be very high, which makes more work for the pilot and is not conducive to increased safety.

Thus, in the above-mentioned zones, a procedure stipulates an auto-information concept between aircraft. Therefore, the pilot of an aircraft has another source of information by which he can know the approximate position of aircraft that he might meet on his path, in other words aircraft said to be “in the same neighborhood”.

This other information source is denoted Blind Broadcast. It is a communication made by each pilot towards all aircraft within VHF range. This communication includes a number of standard data including the following:
the flight No.,
the aircraft altitude and the approximate flight direction,
departure point and arrival point data (airports),
the airway number,
a position data related to passing a reference waypoint on the airway,
time data giving the time at which the aircraft passes this waypoint on the airway,
a position data related to the next reference waypoint to be passed, and
a time data containing the predicted time at which the next waypoint is expected to be passed.

This communication usually includes repetition of the first data items, in other words the flight number, the altitude and the general direction.

Each pilot normally broadcasts this communication at intervals, for example repeated every 20 minutes. It is also broadcast when the aircraft reaches a given altitude or at an altitude change. And it is also broadcast when a waypoint is passed.

A final safety mechanism to prevent collision between two aircraft consists of a known system called TCAS (Traffic Collision Avoidance System). Essentially this consists of a transponder that is installed on some aircraft, and is capable of broadcasting an artificial echo in response to a transmitted signal. This TCAS system may be equipped with an alarm means informing the pilot of a risk of conflict within less than one minute.

The state of the art is also illustrated in document reference (1) at the end of the description.

Document reference (1) describes an aircraft separation process based on an automatic information exchange directly between aircraft. The use of such a process depends on requirements for example such as harmonization of automatic exchange protocols between aircraft equipment. It also assumes that other aircraft are equipped with an appropriate device.

The purpose of this invention is to propose a method and onboard device for providing pilot assistance in the lack of air control in order to simplify interpretation of blind broadcast data to predict a risk of conflict between two aircraft with better precision and more reliably.

Another purpose is to enable the pilot to better appreciate the position and the relative movement between an aircraft in the neighborhood and his own aircraft.

Another purpose is to increase flight safety even in regions with very little ground control equipment.

Finally, another purpose is to propose a method that could be used without it being necessary for other aircraft to be equipped with a particular device.

### PRESENTATION OF THE INVENTION

In order to achieve these purposes, the objective of the invention is a device onboard an aircraft providing pilot assistance in the lack of air control, within the context of IFBP and TIBA procedures, characterized in that it comprises:
means of receiving blind broadcast messages on a dedicated frequency,
means of inputting relevant data for the blind broadcast message, transmitted by at least one aircraft in the neighborhood, using a keyboard,
means of calculating the estimated current position, of the path being followed, and the direction of flight along the path of the aircraft in the neighborhood, extrapolated from data within the blind broadcast message,
means for concomitant display of the extrapolated position and path of the aircraft in the neighborhood, and the current position of the aircraft on which the said device is installed.

With the device according to the invention, the pilot is informed of data about the aircraft in the neighborhood at the time that the blind broadcast message is transmitted, and also at intermediate moments when the aircraft in the neighborhood is in intermediate positions between the announced positions. Admittedly, intermediate positions are estimated by calculation and are not real precise positions, but nevertheless they give a very good estimate of a risk of conflict. They can also be used to evaluate this risk well before it actually occurs. If there is no new blind broadcast message, estimated positions can be extrapolated beyond the second position in the most recently received message.

Calculation means, which may for example be an onboard computer, may be designed to calculate one or several extrapolated intermediate positions, or even (preferably) to continuously calculate the intermediate extrapolated position of one or several aircraft in the neighborhood.

Moreover, with the concomitant display of the position of the aircraft in the neighborhood and the aircraft on which the device according to the invention is installed, the pilot can measure the risk of conflict, without having to remember data transmitted during the communication from the last blind broadcast.

The position of the aircraft on which the device according to the invention is installed is obtained using positioning equipment known in itself, such as GPS (Global Positioning System), IRS (Inertial Reference system or navigation by information from inertial units), FMS Flight Message System), GPIR (Ground Penetrating Imaging Radar-navigation by synthesizing GPS and IRS information (much more accurate)), radio-navigation, etc.

Advantageously, the display means may include an MCDU (Multipurpose Control Display Unit) type data input and display unit, and concomitantly, an ND (Navigation Display) unit, used primarily for displaying the current position and path of the aircraft.

Very frequently, aircraft are already equipped with such an MCDU unit used to display other data, including flight data and the position of the aircraft on which the equipment is installed.

Data input means for blind broadcast messages may be equipped with a manual keyboard, for example such as the alphanumeric keyboard usually associated with known MCDU units.

The fact that the pilot is able to input data for blind broadcast messages leaves him free to filter these data and only select data for aircraft for which the route or the general direction could genuinely interfere with his own route.

According to an improvement to the device, it may also be equipped with a warning device controlled by calculation means to signal a risk of conflict between the aircraft in the neighborhood and the aircraft on which the device according to the invention is installed.

The warning device may be a horn or a visual alarm, with an adjustable trigger threshold.

Advantageously, the device according to the invention also comprises means of providing assistance in inputting the path of an aircraft in the neighborhood and/or means of providing assistance in updating data for an aircraft in the neighborhood.

The invention also relates to a method for providing pilot assistance in the lack of air control comprising the following steps controlled from an aircraft:
radio reception of at least one blind broadcast message on a dedicated frequency,
filtering of blind broadcast messages from aircraft that are not likely to cross the route of the said aircraft, or for which the separation distance from the route is so large that there is no point in making a more precise estimate of the risk of conflict,
inputting at least one blind broadcast message on a data keyboard, transmitted by at least one aircraft in the neighborhood, the blind broadcast message including at least one airway data item, one data item defining a first flight position, a first time data item defining the instant at which the first flight position is reached, a second flight position data item, in the future, and a second estimated time data item defining the instant at which the second flight position will be reached,
calculation of at least one extrapolated position of the aircraft in the neighborhood, starting from data in the blind broadcast message,
concomitant display of the extrapolated position of the aircraft in the neighborhood and the position of the aircraft in which the process is being used.

As mentioned above, the extrapolated position may be an intermediate position between the first and second positions.

For example, with this method the aircraft ground speed in the neighborhood can be calculated. The ground speed can be obtained starting from a distance separating the first and second flight positions of the aircraft in the neighborhood along the airway, and a duration separating the first and second time data. The aircraft position in the neighborhood along its airway is then calculated as a function of the first flight position, the flight ground speed and a current time indication. For example, the current time indication may be the current time or the time elapsed since the first time indication.

The extrapolated position may be calculated in a discrete and one-off calculation. It may also be done continuously, for example for a dynamic display of the variation of the position of aircraft in the neighborhood.

In one particular embodiment of the method according to the invention, the current extrapolated position of the aircraft in the neighborhood can also be compared with the current position of the aircraft in which the method is used. This could be used to trigger a signal when the vertical and horizontal components of the distance between these positions are less than determined set values.

This is one arrangement that could signal the approach of a risk of conflict.

Aircraft altitude data may also be used in the calculation of vertical and horizontal components of the distance between aircraft positions.

### BRIEF DESCRIPTION OF THE DRAWINGS

Other characteristics and advantages of the invention will become clearer from the following description with reference to the FIGURE in the attached drawing. This description is given for illustrative purposes only and is in no way limitative.

The single FIGURE shows a very diagrammatic summary of the main equipment and steps involved in the implementation of a method providing pilot assistance according to the invention.

### DETAILED DESCRIPTION OF EMBODIMENTS OF THE INVENTION

The aircraft 10 illustrated in the FIGURE is an aircraft in the neighborhood of the aircraft in which the device according to the invention is installed. This aircraft 10 is moving along an airway and as it moves it passes through reference waypoints.

The pilot of the aircraft in the neighborhood 10 transmits on a dedicated frequency, for example 126.9 MHz, information messages. These are blind broadcast messages. As explained above, these messages are distributed when precise events occur, for example when passing through a waypoint, or by default every 20 minutes.

The following is one example of such a message.

“All Stations” (Message to all stations)

“This is AIR AFRICA 001”, (Airline name and flight No.)

“Flight Level 310” (Flight level 310, which means 3100 feet altitude)

“EAST BOUND” (general direction)

“From Luanda to Nairobi via UG450” (departure location and destination location+route number)

“UVAGO at 1944” (last waypoint passed at 19 h 44 minutes)

“Estimating UNIRI 2025” (next waypoint and estimated time at this waypoint)

“AIR AFRICA 001, FL310” (repetition of some data items)

“EAST BOUND”.

Step 12 on the FIGURE represents reception of this message by an aircraft. The pilot of this aircraft receives such messages by radio on this dedicated frequency originating from a large number of aircraft moving within the transmission range of broadcast messages.

These messages are taken into account including a filter step 14 done by the pilot that consists of ignoring blind broadcast messages from aircraft that are not likely to cross the route of the aircraft in which the pilot is located, or that are separated from it by a distance that is so large that there is no point in making a more precise estimate of the risk of conflict.

After this first filtering, or in case of doubt, the pilot inputs relevant data on a keyboard 16, for example an MCDU unit connected to an onboard computer 18. The input data may include all data in the blind broadcast message, or they may only include first and second flight position data together with their corresponding time data. For example, they may be waypoints and indications of real or estimated times of passing through these waypoints.

This onboard computer 18 is designed to calculate (possibly in real time) the position of each aircraft in the neighborhood for which data have been input, in other words the state of the surrounding traffic.

This onboard computer 18 also receives position information (latitude, longitude, flight level) input from navigation computers.

Therefore, this onboard computer 18 determines (for example cyclically) the position of each aircraft in surrounding traffic by interpolation of information previously input by the pilot, and he then presents calculated positions of the different aircraft in the neighborhood and their predicted trajectories on a screen in the cockpit.

All aircraft on which an MCDU unit is already installed are equipped with an FMS containing waypoints and airways for the overflown region in a database, including their characteristics and particularly geographic positions (latitude, longitude).

The current position of an aircraft in the neighborhood may be calculated using the following calculation steps:
a) Calculate the distance D separating the two positions along the path for which data have been input.

For example, this may be the distance separating the two waypoints on the route of the aircraft in the neighborhood. The route of the aircraft in the neighborhood may be input. It may also have been saved beforehand on the onboard computer which is then capable of restoring it given two waypoints.
b) Calculate the duration Δt separating time data associated with position data. For example, this may be real or estimated time data provided with the waypoints.
c) Calculate the ground speed Vₛ of the aircraft in the neighborhood by dividing the distance D by the duration Δt.
d) Calculate an extrapolated estimated aircraft position in the neighborhood, along its route. This calculation is made by adding a distance d traveled at the current instant t since the time t0 at which it passed through the known position, to a previously known position, for example the position corresponding to the first position data. This distance d along the path, in this case the airway (broken line) is such that:

d=Vₛ*(t−t₀).

When the aircraft in the neighborhood does not change flight level between first and second broadcast waypoints WP1 and WP2, its ground speed may be assumed to be constant. On the other hand, a correction may be used when the aircraft in the neighborhood changes level.

If Vₛ₁ and Vₛ₂ are the estimated flight ground speeds at positions WP1 and WP2, and Δt₁ is the time elapsed since passing through WP1, a ground speed Vₛ can be used for the calculation, for example such that:

Vₛ=Vₛ₁+Δt₁/Δt*(Vₛ₂−Vₛ₁).

A display screen 20 controlled by the onboard computer 18 is designed to display the position of the aircraft in the neighborhood obtained by the calculation, in an arbitrary form. The position of this aircraft in the neighborhood is displayed concomitantly with the position of the aircraft on which the device according to the invention is installed, so that the pilot can make a visual estimate of the risk of conflict. Other data such as aircraft routes, waypoints, etc. could also be displayed on the same screen.

In one preferred embodiment of the device according to the invention, considering the potential inaccuracy of information provided verbally by pilots, the position of each aircraft is displayed in the form of an area 21 inside which it is considered that the aircraft is probably located. For example, this area 21 may be represented on the screen 20 in the form of a circle, the diameter of which may depend on the age of the information input into the computer. The diameter of this circle may become larger as the age of this information increases, to take account of the interpolation error (that increases with time) of the current position of the aircraft starting from its position at the time at which the said information was received and its planned path.

Therefore, the radius of such a circle is proportional to an uncertainty of the estimated position. The uncertainty includes a fixed component (about 20 nautical miles) related to the error on position data, and a component that depends on time (approximately 2 nautical miles per hour) that corresponds to a pessimistic position drift.

In one embodiment of the invention, when aircraft are fitted with an ADS-B equipment (method according to which aircraft automatically and cyclically exchange positions), the display on the said screen is controlled so as to also take account of information supplied by this ADS-B equipment and the said information input by the pilot, and in this case the pilot's information is less voluminous which saves time. Preferably, this display makes a distinction between aircraft for which the position is received by this equipment and aircraft for which the position is determined according to the invention.

For example, for traffic known to this equipment, aircraft are symbolized by a precisely positioned aircraft reference symbol shown along the direction of its relative heading.

For traffic known through the device according to the invention, the aircraft are not symbolized in position. A margin of uncertainty of the traffic position and path is necessary, depending on the source of the information. Thus, these aircraft are symbolized by a probability of presence area. This circular area has an initial diameter of 20 NM (nautical miles). The area becomes larger in time as defined by concentric circles, to take account of the age of the information (increasing age implies increasing uncertainty about the position). Each circle is 5 NM larger than the previous circle. A label is associated with each traffic symbol. The information displayed is the traffic call sign, the vertical information about its path (level alone or departure and target levels) and the current ATC route. The label follows the symbol as it moves.

Advantageously, the method and the device according to the invention are also capable of detecting a conflict between the aircraft path and the path of another aircraft determined either from the said information input by the pilot or from data obtained using the ADS-B equipment. A pilot is notified of such a potential conflict of paths, for example by modifying the display color on the screen of the aircraft concerned so as to differentiate it from other aircraft (for example amber display of the symbol representing this aircraft).

The pilot may estimate a risk of conflict, but in some cases the estimate may also be the result of the calculation made by the onboard computer 18. Consequently, the reference 22 denotes an emergency warning device that is only activated if this computer 18 detects a risk of conflict.

The warning device signal is only triggered when a number of parameter-controlled conditions are respected.

For example, a risk of conflict could be signaled if: [(the aircraft levels could intersect) OR (the aircraft are moving on the same level within X feet)] AND [(the aircraft are on the same airway) OR (the airways followed by the aircraft intersect) OR (the airway of the close aircraft is unknown) AND (the direct horizontal distance between the two aircraft is less than Y NM)].

X and Y are thresholds to be adjusted after debugging.

The “Aircraft levels intersect” condition means that the aircraft in the neighborhood is changing level from a current level to a later level and that these two levels are on opposite sides of the level of the aircraft on which the device according to the invention is installed.

The device according to the invention may also include two other accessory items of equipment:
equipment providing assistance for inputting the path of an aircraft in the neighborhood,
equipment providing assistance for updating data for an aircraft in the neighborhood.

These two items of equipment are described below.

Equipment Providing Assistance for Inputting the Path of an Aircraft in the Neighborhood

The pilot is provided with a displayed list of available airways. In the vast majority of cases, airways displayed on the first page must contain the routes to be recorded of aircraft in the neighborhood.

The device according to the invention preselects the routes of aircraft in the neighborhood contained within a circle of Z NM (a few hundred nautical miles), depending on the current position of the aircraft. The device according to the invention sorts routes that have a common waypoint and routes that have an intersection with the route of the aircraft in which the device is installed. In priority it displays concurrent routes for which the intersection is closest to the position of the aircraft in which it is installed, along the flight direction of the aircraft. This type of display on an input device enabling direct selection of the route concerned (without typing) is an advantage in that:
the pilot is not obliged to type in the characters of the name of the airway;
the pilot may have forgotten the name of the airway that he heard on the dedicated frequency, or he may not have heard it correctly, or he may have a doubt about how to spell it.

Once the route of the aircraft in the neighborhood to be recorded is known, the pilot must select the waypoint along the route in which he is interested. The device according to the invention proposes a list of waypoints on the said route. To facilitate the selection, the list starts from a so-called reference point chosen according to different criteria, listed below. The pilot is shown points located on each side of the reference point by default, without making any preliminary judgment about the direction of movement along the route.

The selection criteria may be as follows:
1) If the aircraft in the neighborhood to be recorded is on the same TS route as the route of the aircraft on which the device according to the invention is installed, the reference waypoint is the next waypoint over which the aircraft in which the device according to the invention is installed will fly.
2) If there is a common waypoint between routes, the device according to the invention displays the common waypoint as reference. It then displays two lists: the list of waypoints following the reference in one direction, and the list of waypoints following the reference in the other direction.
3) If there is no common waypoint but there is a common intersection X, the device according to the invention names this point X using the following rule: X followed by the name of the route of the aircraft in the neighborhood to be recorded. The device according to the invention then displays this point as the reference. The waypoint could also be chosen on the known route closest to the intersection. But in the procedure, pilots are asked to make a report 5 minutes before the crossing or the junction with a route (“CROSSING UA607 AT . . . ”). This is then the only means available to the pilot to take account of this estimate.

If there is no common waypoint or intersection, the chosen reference is the waypoint closest to the current position of the aircraft in which the device according to the invention is located, along the route concerned.

Once again, this type of display on an input device is undoubtedly an advantage in that:
The pilot is not obliged to type the characters of the waypoint name,
The pilot may have forgotten the name of the waypoint that he heard on the dedicated frequency, or he may not have heard it correctly, or he may have a doubt about how to spell it.

As for the position report, the pilot needs to enter three data defining the estimated position. Considering that there is a strong probability that this estimated position is on the same route as the position report, the function makes a preliminary judgment about the airway and thus by default the airway in the position report is entered in the “airway” field. The pilot then simply needs to select the waypoint in which he is interested. As before, the device according to the invention proposes a list of waypoints on this route. The list starts from the report point, to facilitate the selection. By default, the points located on each side of the report point are displayed to the pilot, without making any preliminary judgment about the direction of motion along the route.

Equipment Providing Assistance for Updating Data for an Aircraft in the Neighborhood

When traffic known through the device according to the invention reaches its estimated point (extrapolated by calculation), the symbol continues to move on the navigation screen (for example ND). In fact, automatic sequencing is done assuming that the aircraft continues its flight along its last defined route, from waypoint to waypoint at a constant speed equal to the last extrapolated speed.

The pilot accesses these data on particular traffic revision fields, in the input device. The fields describing the report and estimated points are replaced by extrapolated data.

If the pilot has up-to-date information after reception of a message from an aircraft in the neighborhood, he can then either correct or confirm the extrapolated data (confirming the passage time automatically confirms the associated point).

The symbol displayed on the navigation screen representing the aircraft in the neighborhood will be displayed differently depending on whether the position of this aircraft is derived from extrapolated information or if it is confirmed by a message from the pilot of this aircraft.

### REFERENCES

(1) “The 3FMS concept for Airborne Separation assurance Systems” by Daniel Ferro and Gérard Saint Huile (Human Computer Interaction (HCI) Conference—AERO 2000, Toulouse, October 2000).

1. Device onboard an aircraft providing pilot assistance to an aircraft pilot in a region of the world lacking ground based air traffic control, wherein the device comprises:
a transmitter to transmit at determined intervals, and when the aircraft reaches a given altitude or an altitude change and when a waypoint is passed, a first blind broadcast message on a dedicated frequency within VHF range to all other aircraft in a neighborhood of an airspace not having ground based air traffic control;
a receiver to receive at least one second blind broadcast message on the dedicated frequency within a neighborhood, wherein the second blind broadcast message is transmitted from another aircraft in the neighborhood airspace at the dedicated frequency within the VHF range;
an onboard computer to take into account relevant data from the at least one received second blind broadcast message transmitted by the another aircraft and connected to a keyboard to receive the relevant data and the onboard computer to calculate at least one estimated current position of the another aircraft, a path being followed by the another aircraft, and a direction of flight along the path of the another aircraft in the airspace, extrapolated from inputted data within the at least one second blind broadcast message from the another aircraft;
a display to display concomitantly the estimated current position and path of the another aircraft with respect to a current position of the aircraft on which the device is installed based on the second blind broadcast message, said estimated current position displayed in a form of areas on a display which represents where the aircraft is located;
a detector to detect a potential conflict between the path of the aircraft and the path of the another aircraft; and
a warning device to notify the potential conflict to at least one of the pilots.

2. Device according to claim 1, wherein said warning device controlled by said onboard computer to signal a risk of conflict between the aircraft in the neighborhood and the aircraft on which the device is installed.

3. (canceled)

4. Device according to claim 1, in which the display includes an MCDU (Multipurpose Control Display Unit) type unit.

5. Device according to claim 1 comprising means for providing pilot assistance in inputting the path of the another aircraft in the neighborhood.

6. Device according to claim 1 comprising means for providing assistance in updating data for an aircraft in the neighborhood.

7. (canceled)

8. Method for providing pilot assistance to the pilot in a first aircraft in a region of the world lacking ground based air traffic control area, the method comprising:
transmitting a first blind broadcast message at determined intervals and when a first aircraft reaches a given altitude and when a waypoint is passed towards all other aircraft in a neighborhood on a dedicated frequency within VHF range in an airspace lacking ground based air traffic control;
receiving at least one second blind broadcast message on a dedicated frequency at a device in the first aircraft, the at least one second blind broadcast message being transmitted from a second aircraft in a neighborhood and within the VHF range;
inputting, on a keyboard of the first aircraft, relevant data associated with the received at least one second blind broadcast message transmitted by the second aircraft, the received at least one blind broadcast message including at least one airway data item, one data item defining a first flight position, a first time data item defining an instant at which the first flight position is reached, a second flight position data item, and a second estimated time data item defining an instant at which the second flight position will be reached;
calculating at least one estimated current position of the second aircraft from inputted data in the at least one second blind broadcast message and a path being followed and direction of flight along the path by the second aircraft, the estimated current position being extrapolated from the inputted relevant data;
displaying the extrapolated position of the second aircraft and a position of the first aircraft, said positions being displayed in a form of areas which is considered that the first aircraft is located based on the first blind broadcast message;
detecting a potential conflict between the path of the first and second aircrafts; and
notifying the potential conflict to at least one pilot.

9. Method according to claim 8, in which a current extrapolated position is calculated as an intermediate position between the first and second flight positions estimated by calculation at the time prior to the second blind broadcast message being transmitted.

10. Method according to claim 8, in which the ground speed of the second aircraft is calculated starting from a distance separating the first and second flight positions of the second aircraft in the neighborhood along the airway, and as a function of a duration separating the first and second time data, and in which a position of the second aircraft is calculated in the neighborhood along the airway, as a function of the first flight position, the flight ground speed and as a function of current time data.

11. Method according to claim 10, in which a current intermediate extrapolated position of one or several other aircraft in the neighborhood is calculated continuously.

12. Method according to claim 8, in which a current extrapolated position of the second aircraft is compared with a current position of the first aircraft a risk of conflict signal is triggered if vertical and horizontal components the distance between the positions of the first aircraft and the second aircraft are less than predetermined values.

13. Method according to claim 12, wherein the first and second positions of the respective aircraft in the neighborhood comprise altitude data which is used in the calculation of the vertical and horizontal components of the distance between aircraft positions.

14. Device onboard a first aircraft for providing pilot assistance in a region of the world lacking groudn based air traffic control comprising:
means for emitting blind broadcast messages on a dedicated frequency towards all aircraft within VHF range at determined intervals and when the first aircraft reaches a given altitude and passes a waypoint;
means for receiving at least one second blind broadcast message transmitted by a second aircraft within a desired distance from the first aircraft and in an airspace not having ground based air traffic control, the blind broadcast message transmitted from the second aircraft and received in the first aircraft;
means for manually inputting relevant data associated with transmitted information in the at least one second blind broadcast message into said device;
means for calculating an estimated current position of the second aircraft from the inputted data; and
means for calculating a flight path of the second aircraft from the blind broadcast message, wherein said means for calculating determines whether a point of collision will exist between the first aircraft and second aircraft based on the flight path of the second aircraft and operating data of the first aircraft;
means for detecting a potential conflict between the flight paths of the first and second aircrafts; and
means for notifying the potential conflict to at least one pilot.

15-17. (canceled)
